(19) United States
(12) Patent Application Publication
(10) Pub. No.: US 2026/0151952 A1
(43) Pub. Date: Jun. 4, 2026

(54) Apparatus and method for producing plastic containers, with inspection

(71) Applicant: KRONES AG, Neutraubling (DE)

(72) Inventors: Simon FISCHER, Regensburg (DE); Andreas STOPFER, Regensburg (DE); Stefan SCHOBER, Tegernheim (DE)

(21) Appl. No.: 18/707,668

(22) PCT Filed: Aug. 16, 2022
(86) PCT No.: PCT/EP2022/072881

§ 371 Date: May 6, 2024

(30) Foreign Application Priority Data
Nov. 5, 2021 (DE) 10 2021 128 918.1

(51) Int. Cl. B29C 49/42; B29C 49/80; B29K 67/00; B29L 31/00

(52) U.S. Cl. CPC B29C 49/42065; B29C 49/80; B29K 2067/003; B29L 2031/7158

(57) ABSTRACT

An apparatus for producing containers includes a transport device which transports plastic preforms along a predefined transport path a forming device which expands the plastic preforms to form plastic containers; a first inspection device which is configured to inspect the plastic preforms; and a second inspection device which is configured to inspect the plastic containers. The the first inspection device has a first inspection region through which the plastic preforms to be inspected pass so that they can be inspected, and the second inspection device has a second inspection region through which the plastic containers to be inspected pass so that they can be inspected. The said first inspection region and said second inspection region overlap at least in part.

### BACKGROUND OF THE INVENTION

The present invention relates to an apparatus and a method for producing plastic containers. Such apparatuses and methods have long been known from the prior art. It is also known that plastic preforms are first heated and then these plastic preforms are expanded to form plastic containers. This can be done, for example, in blow molding machines such as stretch blow molding machines.

It is also known that various inspections are carried out during such production processes. In the production of plastic containers such as PET containers, the wall thickness of the containers produced is an important quality criterion. The wall thickness and its thickness distribution characterize the mechanical properties of the containers. In individual sections of the containers, the weight of these regions is often also detected as a quality parameter. The weight of such regions is also linked to the wall thickness within them. The stability of the wall thicknesses and/or the section weights over time and over different production states characterizes the stability of the production system. This stability can continue to be an important quality parameter.

U.S. Pat. No. 6,863,860 describes a method and an apparatus for checking the wall thickness of blow-molded plastic containers.

In the production of PET containers, the water content of the plastic preforms used also influences processing. On the one hand, the water content is a general quality parameter that is related to the storage period and treatment of the plastic preforms. However, it can also influence the necessary processing parameters in the stretch blow molding process and the subsequent container properties. It can also continue to influence the behavior of the plastic preforms in the heating process, in particular with infrared or microwave radiation.

Furthermore, the production of the PET containers influences the infrared absorption of the plastic preforms, in particular the broadband infrared absorption of the plastic preforms, which influences the heating of the plastic preforms and the machine settings used for this purpose. Batch fluctuations, which are undesirable in themselves and occur in particular when recycled material is used in the plastic preforms, can cause changing infrared absorption.

In the prior art, the wall thickness of the containers produced can be checked using a line of measuring points, for example. Each measuring point uses infrared sensors to detect the absorption of the containers and preferably also of a reference detector at several and preferably two wavelengths at specific points or in narrow regions.

A wall thickness can be deduced from the measurement signals. Such a measuring device can be placed immediately after the container producing device or downstream thereof.

Checking the water content and infrared absorption of the plastic preforms can be carried out in a measurement setup very similar to the wall thickness measurement. However, it is possible that the considered wavelengths, the reference detectors and the optical components differ in their properties.

In the prior art, two inspection devices are therefore provided in these systems, which are used to inspect both the plastic preforms and the plastic containers, for example plastic bottles. This is comparatively complex, in particular when it is taken into account that the measuring principles are at least similar in both cases.

The present invention is therefore based on the object of simplifying the inspections for such apparatuses for producing containers.

### SUMMARY OF THE INVENTION

An apparatus according to the invention for producing plastic containers and in particular plastic bottles has a transport device which transports plastic preforms along a predefined transport path. Furthermore, the apparatus has a forming device which expands the plastic preforms to form plastic containers and a first inspection device and/or control device which is suitable and intended to inspect the plastic preforms. Furthermore, the apparatus has a second inspection device and/or control device which is suitable and intended for inspecting and/or controlling the plastic containers.

According to the invention, the first inspection device has a first inspection region through which the plastic preforms to be inspected pass so that they can be inspected, and the second inspection device has a second inspection region through which the plastic containers to be inspected pass so that they can be inspected, wherein said first inspection region and said second inspection region overlapping and/or coinciding at least in part.

It should be noted that the term inspection device is used uniformly below, but in the context of the present application, an inspection device is also understood to mean a device which inspects and/or controls and/or checks plastic preforms with regard to at least one characteristic feature of said plastic preforms.

In a further preferred embodiment, the first inspection device outputs at least one measured value and/or at least one inspection result which is characteristic of at least one physical property of a plastic preform to be inspected. This can be, for example, a wall thickness of a wall region of a main body of the plastic preform or a transparency or the like.

In a further preferred embodiment, the second inspection device outputs at least one measured value and/or at least one inspection result which is characteristic of at least one physical property of a plastic container to be inspected. This can be, for example, a wall thickness of a wall region of a main body of the plastic container or a transparency or the like.

In a further preferred embodiment, the second inspection device is arranged downstream of the first inspection device in relation to the transport path of the plastic preforms or plastic containers. In a further preferred embodiment, the first and second inspection devices are designed such that a specific plastic preform first passes through the first inspection device and then the plastic container into which this plastic preform was formed passes through the second inspection device.

Preferably, both the plastic preforms and the plastic containers pass through the same inspection region in which the inspection takes place. Preferably, both the transport path of the plastic preforms before they are formed and the transport path of the formed plastic containers pass through this inspection region.

Particularly preferably, the first inspection device and the second inspection device are arranged substantially at the same location on the apparatus. In this way, preferably only one measuring device is required, which is used both for inspecting the plastic preforms and for inspecting the plastic containers.

The forming device is particularly preferably a blow molding machine which expands and in particular blows the plastic preforms to form the plastic containers. In particular, the forming device is a stretch blow molding machine. Preferably, the forming device has a movable and in particular rotatable carrier on which a plurality of forming stations is arranged for forming the plastic preforms into the plastic containers.

Preferably, these forming stations each have blow molds which can be opened and closed, wherein the plastic preforms being expanded to form the plastic containers inside these blow molds. Preferably, these forming stations also have rod-like bodies, such as, in particular but not exclusively, stretching rods, which can be inserted into the interior of the plastic preforms in order to stretch them in their longitudinal direction.

Preferably, the transport device has a plurality of holding and/or gripping devices which grip the plastic preforms at their mouth regions in order to transport them. Particularly preferably, the plastic containers and the plastic preforms are transported at the same height, i.e., the mouths of the plastic preforms or plastic containers are transported at substantially the same height throughout the entire apparatus.

In a further preferred embodiment, in addition to the inspection devices and/or measuring devices, a processor device, for example a detection and processing device, for example a PET view, is provided, which addresses and controls the inspection or measuring devices and preferably evaluates and/or logs their measurement signals, generates statistics and/or makes them available to a user or the operators or, if applicable, downstream systems.

Preferably, a processor device and/or a processing device is provided, which is assigned to both inspection devices. Since the inspections or measurements on the respective plastic preforms and containers are preferably carried out at different times or locations, a single processing device can carry out the evaluation of the measured values of both inspection devices.

Preferably, the apparatus has an assignment device which assigns an inspection result of a specific plastic preform to an inspection result of the plastic container which was formed from this plastic preform. In this way, the inspection results obtained with the first inspection device can be assigned to the inspection results obtained with the second inspection device on the same (only formed) object.

It should be noted that the assignment of the inspection results described here and below can also be advantageous independently of the embodiment with the same inspection regions and the applicant therefore reserves the right to claim separate protection for such an embodiment.

A further apparatus according to the invention for producing plastic containers and in particular plastic bottles has a transport device which transports plastic preforms along a predefined transport path. Furthermore, the apparatus has a forming device which expands the plastic preforms to form plastic containers and a first inspection device and/or control device which is suitable and intended to inspect the plastic preforms. Furthermore, the apparatus has a second inspection device and/or control device which is suitable and intended for inspecting and/or controlling the plastic containers.

According to the invention, the first inspection device has a first inspection region through which the plastic preforms to be inspected pass so that they can be inspected, and the second inspection device has a second inspection region through which the plastic containers to be inspected pass so that they can be inspected, and the apparatus has an assignment device which assigns an inspection result of a specific plastic preform to an inspection result of the plastic container which was formed from this plastic preform.

In a further advantageous embodiment, the apparatus has at least one evaluation device which evaluates at least one inspection result of the first inspection device and/or at least one inspection result of the second inspection device and which in particular compares at least one inspection result of the first inspection device with at least one inspection result of the second inspection device.

In this embodiment, it is proposed that measurement results obtained by the first inspection device on a specific plastic preform and measurement results obtained on the plastic container into which this plastic preform was formed are assigned to or correlated with one another.

Preferably, these assigned measurement results or inspection results are further evaluated. This evaluation can take place in the inspection devices or in the evaluation devices assigned thereto. However, it would also be possible for the inspection results or corresponding measurement data to be transmitted to a further evaluation unit and evaluated there.

Preferably, the evaluation device determines at least one correlation between the inspection results assigned to one another, such as a ratio between a wall thickness of the plastic preform in a certain region and a wall thickness of the plastic container produced from said plastic preform (preferably also in this region).

This at least one correlation is particularly preferably used to control the forming device. Preferably, therefore, the forming device has at least one control device which controls the forming process taking into account at least one value which is characteristic of a correlation between the inspection results assigned to one another.

In a preferred embodiment, the evaluation device is suitable and intended to determine correction values from a correlation and/or a comparison between the inspection results and/or a first inspection result, by which the forming process of the plastic preforms can be adapted or which can be used in the forming of the plastic preforms by means of at least one forming station.

Preferably, the correlations can be used to determine correction values for the production of the plastic container from this particular plastic preform after measuring the plastic preform. In this way, deviations from the desired measurement results of the plastic container produced can be minimized.

In a further preferred embodiment, the apparatus has a further assignment device which assigns at least one inspection result output by the first inspection device and/or at least one inspection result output by the second inspection device to at least one forming station of the forming device or at least one transport device and/or at least one holding device for holding the plastic preforms or plastic containers.

Preferably, therefore, the measured values or the inspection results of the first inspection device and/or the measured values or the inspection results of the second inspection device are assigned to at least one transport device and, in particular, assigned to the individual transport devices on or by which the plastic preforms and/or the containers are transported.

In a further preferred embodiment, an evaluation device is provided which evaluates these inspection results in relation to the transport device and/or its holding devices.

In this way, it is possible to systematically recognize exceptionally deviating inspection results for those plastic preforms or plastic containers that were held by certain holding devices (compared to other holding devices). If, for example, a holding device does not hold a plastic preform or a plastic container in a specific target orientation, this can affect individual processes such as the forming process or the heating process.

Preferably, this further assignment device is also suitable for performing an assignment to holding devices which are located upstream of the inspection device, i.e. which had held a specific container at an earlier point in time.

In a preferred embodiment, the first inspection device has a first radiation device, which applies radiation to the transported plastic preforms, and a first detector device, which absorbs radiation emitted by the radiation device and, in particular, radiation that has passed through the plastic preforms. Furthermore, the second inspection device has a second radiation device which applies radiation to the transported plastic containers, and a second detector device which absorbs radiation emitted by the second radiation device and passing through the plastic containers, wherein preferably both the transported plastic preforms and the transported plastic containers can be transported between the two radiation devices and the two detector devices.

Preferably, the respective inspection regions are arranged between the radiation devices and the detector devices.

In this embodiment, a method is proposed in which both the plastic preforms and the plastic containers are illuminated by radiation and the transmitted radiation is detected and/or determined. Preferably, the radiation detector device is suitable and intended to absorb a spectrum of this transported radiation. For example, the water content of the plastic preforms can be determined from this spectrum. Furthermore, it is also possible to deduce the wall thickness of the plastic containers from the transported radiation.

Preferably, the first inspection device is suitable and intended to determine a liquid content and, in particular, a water content of plastic preforms.

In a further advantageous embodiment, the second inspection device is suitable and intended to determine a wall thickness of the finished plastic containers or to determine a value which is characteristic of this thickness.

Preferably, the second inspection device is suitable and intended to determine a wall thickness of the plastic containers as a function of a wall region of the plastic containers. For this purpose, the second inspection device can have a plurality of detector devices which are arranged along a longitudinal direction of the plastic containers.

In a further preferred embodiment, the transport device transports the plastic preforms and also the plastic containers separately. Preferably, the plastic preforms are transported separately over the entire transport route, at least between the first inspection device and the second inspection device. This also enables the above-mentioned assignment.

Particularly preferably, the first inspection region is arranged between the first radiation device and the first detector device and the second inspection region is arranged between the second radiation device and the second detector device. As mentioned above, the two inspection regions are preferably arranged to overlap or coincide.

Preferably, the plastic preforms are therefore transported both between the first radiation device and the first detector device and between the second radiation device and the second detector device.

Accordingly, the plastic containers are also preferably transported both between the first radiation device and the first radiation detector device and between the second radiation device and the second detector device.

Preferably, the plastic containers are PET containers and in particular plastic bottles.

Preferably, at least one radiation device of the first inspection device is also a radiation device of the second inspection device and/or at least one detector device of the first inspection device is also a detector device of the second inspection device.

Particularly preferably, at least one radiation device has a plurality of radiation sources which are arranged next to one another or one above the other in a longitudinal direction of the transported plastic preforms or the transported plastic containers.

In a further advantageous embodiment, the apparatus has a supply device which supplies the plastic preforms to be formed to the forming device, and a discharge device which transports the formed plastic containers away from the forming device. Preferably, both inspection devices are arranged between the supply device and the discharge device. Both inspection devices are preferably arranged in particular geometrically or spatially between the supply device and the discharge device. Preferably, the region located between the supply device and the discharge device is a region through which both the plastic preforms and the plastic containers are transported beforehand.

In a further advantageous embodiment, the supply device and/or the discharge device is a transport starwheel. Particularly preferably, both the supply device and the discharge device are a transport starwheel (or a transport wheel).

In a further preferred embodiment, the supply device and/or the discharge device has a rotatable carrier on which a plurality of holding devices and, in particular, gripping devices for holding and, in particular, gripping the plastic preform or plastic containers are arranged.

Particularly preferably, the supply device is a pitch varying starwheel which changes and in particular increases a pitch between plastic preforms. Such pitch varying starwheels are known from the prior art and are used, for example, to increase a distance between the plastic preforms downstream from an oven so that they can also be transferred to a blow molding machine. Preferably, the inspection is arranged in a region in which the pitch between the plastic preforms has already been increased and, in particular, in a region in which no further increase in this distance takes place. In this way, as explained in more detail below, it is possible for the inspection devices to alternately inspect plastic preforms and plastic containers.

Particularly preferably, both the supply device and the discharge device have a plurality of holding devices and in particular gripping devices which grip the plastic preforms or the plastic containers and in particular grip at their mouth regions and in particular below the mouth. In particular, these gripping devices are suitable and intended to grip the plastic preforms on their outer surfaces.

In a further advantageous embodiment, the first inspection device is suitable and intended to determine a water content of the plastic preforms.

In a further advantageous embodiment, the supply device and the discharge device are arranged such that a minimum distance of a plastic preform transported by the supply device and a plastic container transported by the discharge device is less than 30 cm, preferably less than 25 cm, preferably less than 20 cm, preferably less than 15 cm, preferably less than 10 cm and preferably less than 5 cm. On the other hand, however, the plastic preforms and plastic containers are guided such that the minimum distance is preferably always greater than 3 cm, preferably 4 cm, preferably 5 cm and preferably 10 cm.

Particularly preferably, the plastic containers and the plastic preforms are transported with the same pitch in the region of the first and second inspection device. Particularly preferably, the plastic preforms and plastic containers are transported such that both never pass through inspection regions at the same time.

In a further preferred embodiment, the supply device and the discharge device are arranged such that plastic preforms transported by the supply device and plastic containers transported by the discharge device pass through the inspection regions alternately and preferably in opposite transport directions.

Preferably, the rotatable carriers of the supply device and the discharge device rotate in the same direction of rotation during operation.

The present invention further relates to a method for producing plastic containers, wherein a transport device transports plastic preforms along a predefined transport path and a forming device expands the plastic preforms to form plastic containers and a first inspection device inspects the plastic preforms and a second inspection device inspects the plastic containers.

According to the invention, the first inspection device has a first inspection region through which the plastic preforms to be inspected pass so that they can be inspected, and the second inspection device has a second inspection region through which the plastic containers to be inspected pass so that they can be inspected (or through which plastic containers are transported), wherein this first inspection region and this second inspection region overlapping at least in part.

In a preferred method, the two inspection devices inspect plastic preforms and plastic containers alternately in time. Preferably, the plastic preforms and/or the plastic containers are irradiated by radiation, in particular infrared radiation, for the purpose of inspection. Particularly preferably, the plastic preforms and the plastic containers are transported through the inspection devices and/or the inspection regions in different and, in particular, opposite transport directions.

Preferably, the plastic preforms and the plastic containers are transported such that only one plastic preform or one plastic container is x-rayed and/or inspected at a time. Preferably, the plastic preforms and/or the plastic containers are irradiated with infrared light.

Preferably, the transport speeds of the plastic preforms and the plastic containers in the inspection region are identical.

In a further preferred method, inspection of a plastic preform is also associated with inspection of a plastic container produced therefrom.

Preferably, the plastic preforms and/or the plastic containers are transported separately, as mentioned above.

### BRIEF DESCRIPTION OF THE DRAWINGS

Further advantages and embodiments can be seen in the accompanying drawings:

In the drawings:

FIG. 1 shows a schematic representation of an apparatus according to the invention;

FIG. 2 is a detailed view of the apparatus shown in FIG. 1;

FIG. 3 is a schematic representation of the inspection devices;

FIG. 4 is a top view of the apparatus according to the invention;

FIG. 5 is a further sectional view of the apparatus according to the invention.

### DETAILED DESCRIPTION OF THE INVENTION

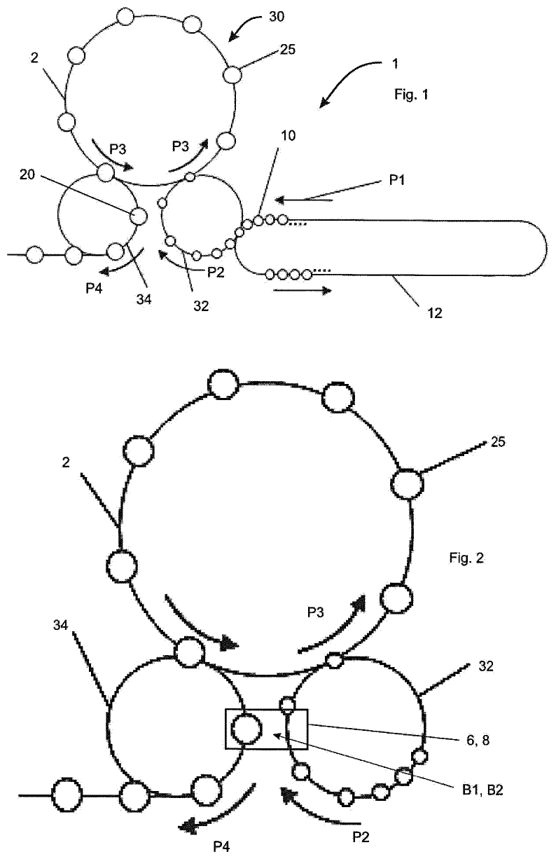

FIG. 1 shows a schematic view of an apparatus 1 according to the invention. A heating device 12 is provided, through which plastic preforms 10 are conveyed along the transport path P1. The plastic preforms are heated. The heating device can be, for example, an infrared oven or a microwave oven.

The plastic preforms are then transferred to a supply device 32 (arrow P2). In this supply device, a pitch or distance between the individual successive plastic preforms is increased. The plastic preforms are transferred to the forming device 30 at this increased distance. The forming device has a transport device 2 in the form of a rotatable carrier on which a plurality of forming stations 25 are arranged, within which the plastic preforms are formed into plastic containers 20 by applying a flowable (and in particular gaseous, but possibly also liquid) medium. The plastic containers are transported along the arrows P3.

The finished plastic containers 20 (arrow P4) are then transported further via a discharge device 34.

FIG. 2 is an enlarged view of the apparatus shown in FIG. 1. It can be seen that in the region between the supply device 32 and the discharge device 34, the plastic preforms 10 and the finished plastic containers 20 come very close to one another. In this way, the applicant has determined that this region is well suited for the installation of an inspection device. Accordingly, the reference signs B1 and B2 indicate the inspection region through which both the plastic preforms 10 and the plastic containers 20 are transported. Accordingly, the reference signs 6 and 8 identify the two inspection devices, more precisely the first inspection device 6 and the second inspection device 8.

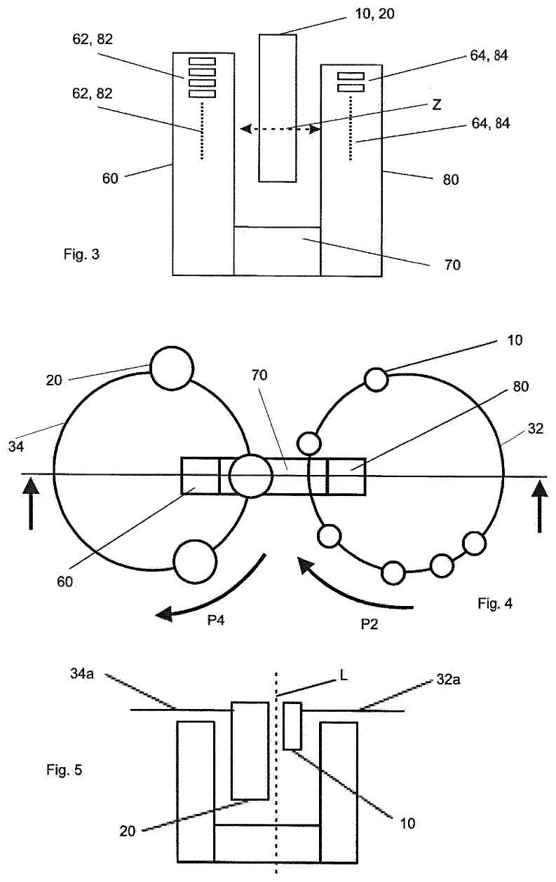

FIG. 3 is a schematic representation of the inspection devices 6, 8. Radiation devices 62, 82 are provided which apply radiation, and in particular infrared light, to the transported objects, i.e. both the plastic preforms 10 and the plastic containers 20. The reference signs 64, 84 each indicate detector devices, which are arranged here on a further detector carrier 80. The reference sign 60 identifies a carrier on which the individual radiation devices of the first and second inspection devices are provided. The detector devices 64, 84 are preferably suitable and intended to detect infrared light.

The reference sign 70 indicates an intermediate carrier on which the two carriers 60 and 80 are arranged. The intermediate space Z between the radiation devices 62, 82 and the detector devices 64, 84 is also the inspection region or represents the two inspection regions B1 and B2.

FIG. 4 is a top view of the apparatus according to the invention in the region between the supply device 32 and the discharge device 34. The connecting carrier 70 and the carriers 60 and 80 of the two inspection devices can also be seen here. It can be seen that both the plastic preforms 10 and the plastic containers 20 are transported through this region and can be inspected in this way.

FIG. 5 is a further representation of the apparatus according to the invention. Gripping devices 32a of the supply device and gripping devices 34a of the discharge device 34 are provided here. The gripping devices 32a are used to grip the plastic preforms 10 and the gripping devices 34a are used to grip the finished plastic containers 20.

As mentioned above, the supply device and the discharge device are preferably arranged such that both a plastic preform 10 and a plastic container 20 are never arranged in the inspection region at the same time. In this way, it is possible for the plastic preforms 10 and the plastic containers 20 to be inspected alternately. However, it is possible that at least individual radiation devices 62, 82 as well as individual detector devices 64, 84 are used both for inspecting the plastic preforms 10 and for inspecting the plastic containers 20.

However, it can be seen in FIG. 5 that the plastic preforms 10 are shorter in the longitudinal direction L than the plastic containers 20. This means that, advantageously, some of the radiation devices and some of the detector devices are only used for inspecting the plastic containers 20, but not for inspecting the plastic preforms 10.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1-14. (canceled)

15. An apparatus for producing plastic containers with a transport device which transports plastic preforms along a predefined transport path, with a forming device which expands the plastic preforms to form plastic containers with a first inspection device which is configured to inspect the plastic preforms and with a second inspection device configured to inspect the plastic containers, wherein the first inspection device has a first inspection region through which the plastic preforms to be inspected pass so that they can be inspected, and the second inspection device has a second inspection region through which the plastic containers to be inspected pass so that they can be inspected, wherein said first inspection region and said second inspection region overlap at least in part.

16. The apparatus according to claim 15, wherein the first inspection device has a first radiation device which applies radiation to the transported plastic preforms and a first detector device which absorbs radiation emitted by the radiation device, and the second inspection device has a second radiation device which applies radiation to the transported plastic containers and a second detector device which absorbs radiation emitted by the second radiation device, wherein both the transported plastic preforms and the transported plastic containers being transportable between the two radiation devices and the two detector devices.

17. The apparatus according to claim 16, wherein the first inspection region is arranged between the first radiation device and the first detector device and the second inspection region is arranged between the second radiation device and the second detector device.

18. : The apparatus according to claim 16, wherein at least one radiation device of the first inspection device is also a radiation device of the second inspection device and/or at least one detector device of the first inspection device is also a detector device of the second inspection device.

19. The apparatus according to claim 15, wherein the apparatus has a supply device which supplies the plastic preforms to be formed to the forming device, and a discharge device which transports the formed plastic containers away from the forming device, and both inspection devices are arranged between the supply device and the discharge device.

20. The apparatus according to claim 19, wherein the supply device and/or the discharge device is a transport starwheel and/or the supply device and/or the discharge device has a rotatable carrier, on each of which a plurality of holding devices for holding the plastic preforms and/or plastic containers is arranged.

21. The apparatus according to claim 19, wherein the supply device is a pitch varying starwheel which changes a pitch between plastic preforms.

22. The apparatus according to claim 15, wherein the first inspection device is configured to determine a water content of the plastic preforms and the second inspection device is configured to determine a wall thickness of the plastic containers.

23. The apparatus according to claim 19, wherein the first supply device and the discharge device are arranged such that a minimum distance of a plastic preform transported by the supply device and a plastic preform transported by the discharge device is less than 30 cm.

24. The apparatus according to claim 19, wherein the supply device and the discharge device are arranged such that the plastic preforms transported by the supply device and the plastic containers transported by the discharge device pass through the inspection regions alternately.

25. The apparatus according to claim 15, wherein the apparatus has an assignment device which assigns an inspection result of a specific plastic preform to an inspection result of the plastic container which was formed from this plastic preform.

26. The apparatus according to claim 15, wherein the apparatus has a further assignment device which assigns at least one inspection result output by the first inspection device and/or at least one inspection result output by the second inspection device to at least one forming station of the forming device or at least one transport device and/or at least one holding device for holding the plastic preforms or plastic containers.

27. The apparatus according to claim 15, wherein the apparatus has an evaluation device which evaluates at least one inspection result of the first inspection device and/or at least one inspection result of the second inspection device.

28. A method for producing containers, wherein a transport device transporting plastic preforms along a predefined transport path and a forming device expanding the plastic preforms to form plastic containers and a first inspection device inspecting the plastic preforms and a second inspection device inspecting the plastic containers, wherein the first inspection device has a first inspection region through which the plastic preforms to be inspected pass so that they can be inspected, and the second inspection device has a second inspection region through which the plastic containers to be inspected pass so that they can be inspected, wherein said first inspection region and said second inspection region overlap at least in part.

29. The method for producing containers according to claim 28, wherein the first inspection device has a first radiation device which applies radiation to the transported plastic preforms and a first detector device which absorbs radiation emitted by the radiation device, and the second inspection device has a second radiation device which applies radiation to the transported plastic containers and a second detector device which absorbs radiation emitted by the second radiation device, wherein both the transported plastic preforms and the transported plastic containers being transportable between the two radiation devices and the two detector devices.

30. The method for producing containers according to claim 29, wherein the first inspection region is arranged between the first radiation device and the first detector device and the second inspection region is arranged between the second radiation device and the second detector device.

31. The method for producing containers according to claim 29, wherein at least one radiation device of the first inspection device is also a radiation device of the second inspection device and/or at least one detector device of the first inspection device is also a detector device of the second inspection device.

32. The method for producing containers according to claim 28, wherein the apparatus has a supply device which supplies the plastic preforms to be formed to the forming device, and a discharge device which transports the formed plastic containers away from the forming device, and both inspection devices are arranged between the supply device and the discharge device.

33. The method for producing containers according to claim 32, wherein the supply device and/or the discharge device is a transport starwheel and/or the supply device and/or the discharge device has a rotatable carrier, on each of which a plurality of holding devices for holding the plastic preforms and/or plastic containers is arranged.

34. The method for producing containers according to claim 32, wherein the supply device is a pitch varying starwheel which changes a pitch between plastic preforms.

35. The method for producing containers according to claim 28, wherein the first inspection device is configured to determine a water content of the plastic preforms and the second inspection device is configured to determine a wall thickness of the plastic containers.

36. The method for producing containers according to claim 32, wherein the first supply device and the discharge device are arranged such that a minimum distance of a plastic preform transported by the supply device and a plastic preform transported by the discharge device is less than 30 cm.

37. The method for producing containers according to claim 32, wherein the supply device and the discharge device are arranged such that the plastic preforms transported by the supply device and the plastic containers transported by the discharge device pass through the inspection regions alternately.
